(19) United States
(12) Patent Application Publication
(10) Pub. No.: US 2024/0052509 A1
(43) Pub. Date: Feb. 15, 2024

(54) BIPOLAR POLYMER ELECTROLYTE MEMBRANE FOR WATER ELECTROLYSIS AND MANUFACTURING METHOD THEREOF

(71) Applicant: RESEARCH & BUSINESS FOUNDATION SUNGKYUNKWAN UNIVERSITY, Suwon-si (KR)

(72) Inventors: Duk Joon KIM, Seoul (KR); Ye Eun JEON, Suwon-si (KR); Cong Tinh VO DINH, Suwon-si (KR); Dong Thuc VU, Suwon-si (KR)

(73) Assignee: RESEARCH & BUSINESS FOUNDATION SUNGKYUNKWAN UNIVERSITY, Suwon-si (KR)

(21) Appl. No.: 18/364,032

(22) Filed: Aug. 2, 2023

(30) Foreign Application Priority Data
Aug. 2, 2022 (KR) 10-2022-0095944

(51) Int. Cl. C25B 13/08; C25B 1/04; C25B 9/21

(52) U.S. Cl. CPC C25B 13/08; C25B 1/04; C25B 9/21

(57) ABSTRACT

Disclosed are a bipolar polymer electrolyte membrane for water electrolysis and manufacturing method thereof. A bipolar polymer electrolyte membrane for water electrolysis according to the present disclosure may comprise a proton exchange membrane that is composed of a first compound including a poly(fluorene biphenyl indole) polymer compound as a main chain and an aliphatic hydrocarbon group having a cation exchange group on a side chain of the polymer compound, and an anion exchange membrane that is composed of a second compound represented by Formula 1 below, wherein the proton exchange membrane and the anion exchange membrane have structures bonded to each other:

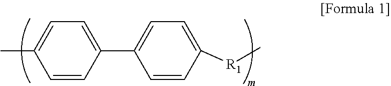

in Formula 1, R₁ is the anion exchange group and m is an integer from 70 to 90.

### CROSS REFERENCE TO RELATED APPLICATION

The present application claims priority to Korean Patent Application No. 10-2022-0095944, filed on Aug. 2, 2022, the entire contents of which is incorporated herein for all purposes by this reference.

### BACKGROUND

### 1. Field

The present disclosure relates to a bipolar membrane that can be used as an electrolytic polymer electrolyte membrane, and relates to a bipolar polymer electrolyte membrane for water electrolysis capable of energy-efficient hydrogen production with high chemical and mechanical stability and a method for manufacturing the same.

### 2. Description of Related Art

Water electrolysis is the easiest way to produce hydrogen. However, most of the water electrolysis studies that have been researched and developed domestically and internationally have low current densities and relatively high overvoltage, resulting in poor efficiency, which makes mass production and commercialization difficult.

Specifically, in the case of the first developed alkaline water electrolysis technology, although the price of the device is low, there is a problem in that performance degradation is accelerated at low current density due to corrosion problems caused by alkaline liquid and output variability due to climate change when combined with renewable energy.

Polymer electrolyte membrane water electrolysis technology, which has been studied since then, has the advantage of being resistant to output variability, being able to operate at high current density, and being non-corrosive and able to operate for a long period of time. Among them, in the case of water electrolysis technology using a proton exchange membrane (PEM), since it is operated under acidic conditions, there is a disadvantage in that process cost increases due to the use of a noble metal catalyst. To lower the catalyst cost, an anion exchange membrane (AEM) water electrolysis technology operated in an alkaline environment has been proposed. However, since the anion exchange membrane has lower water electrolytic performance than that of the proton exchange membrane (PEM) and has low stability in an alkaline environment, more research is needed.

Meanwhile, in a water electrolysis electrode reaction using conventional proton exchange membrane and anion exchange membrane, the theoretical voltage required for water decomposition at 25° C. and 1 atm is 1.23V. However, additional overvoltage is required to overcome the ohmic resistance that is generated from an oxygen evolution reaction (OER) occurring at the anode of the proton exchange membrane and a hydrogen evolution reaction (HER) occurring at the cathode of the anion exchange membrane, which has a problem of lowering energy efficiency.

Therefore, the study of a polymer electrolyte membrane having high water electrolysis performance and excellent chemical stability in an acidic or alkaline environment has emerged as an object to be achieved in the entire water electrolysis system.

### SUMMARY

One object of the present disclosure is to provide a bipolar polymer electrolyte membrane for water electrolysis capable of producing hydrogen even at low voltage and having excellent chemical stability even in an acidic or alkaline environment.

Another object of the present disclosure is to provide a method for manufacturing the bipolar polymer electrolyte membrane for water electrolysis.

In order to achieve one object of the present disclosure, a bipolar polymer electrolyte membrane for water electrolysis may comprise a proton exchange membrane that is composed of a first compound including a poly(fluorene biphenyl indole) polymer compound as a main chain and an aliphatic hydrocarbon group having a cation exchange group on a side chain of the polymer compound; and an anion exchange membrane that is composed of a second compound represented by Formula 1 below, wherein the proton exchange membrane and the anion exchange membrane may have structures bonded to each other.

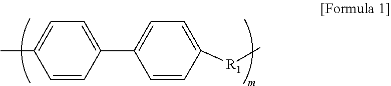

In Formula 1, R₁ is the anion exchange group and m is an integer from 70 to 90.

In one embodiment, the first compound may be represented by Formula 2

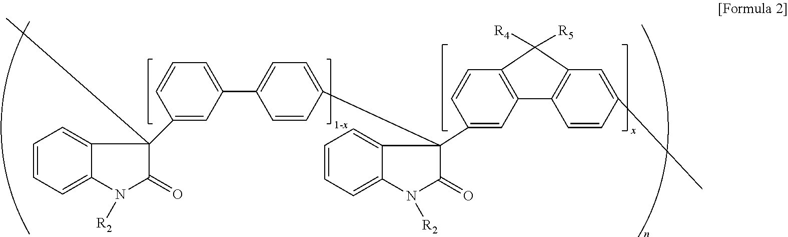

In Formula 2, R₂ to R₅ are alkyl groups having 3 to 10 carbon atoms having the cation exchange group at terminal ends, and x is 0.2 to 0.4; n is an integer from 70 to 90.

In one embodiment, the cation exchange group may be selected from a sulfone group (—SO₃), a phosphoric acid group (—PO₄(−)) and a carboxy group (—COOH).

In one embodiment, the cation exchange group may be the sulfone group (—SO₃).

In one embodiment, the first compound may be represented by Formula 2-1 below.

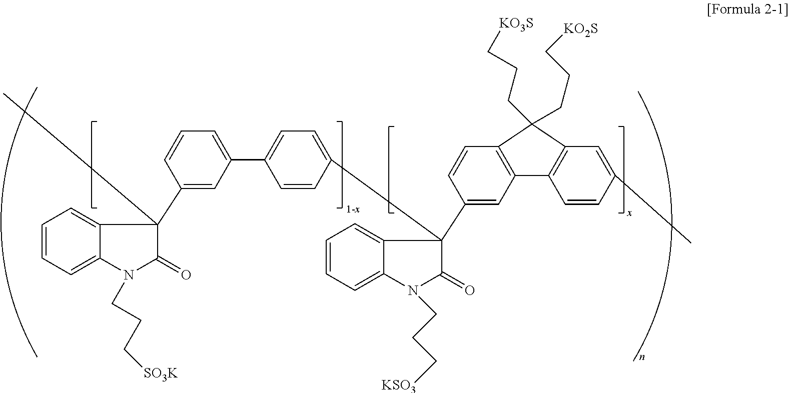

In Formula 2-1, x is 0.2 to 0.4; n is an integer from 70 to 90.

In one embodiment, the anion exchange group may be selected from 1-dimethyl piperidinium, 1-methyl-piperidinium, 1,4-dimethyl-piperidinium, 1,3,5-trimethyl-piperidinium, 1,2,6-trimethylpiperidinium, benzimidazolium, and 1-butyl-1-methylpiperidinium.

In one embodiment, the second compound may be represented by Formula 1-1.

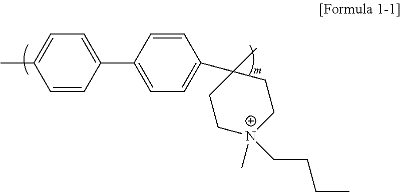

In Formula 1-1, m may be an integer from 70 to 90.

In one embodiment, a bonding portion of the proton exchange membrane and the anion exchange membrane may have a uniform interface.

In one embodiment, a difference in ion conductivity between the proton exchange membrane and the anion exchange membrane may be 0.0001 S/cm to 0.01 S/cm.

Meanwhile, in order to achieve another object of the present disclosure, a method for manufacturing a bipolar polymer electrolyte membrane for water electrolysis of the present disclosure may comprise the steps of hydrating a proton exchange membrane that is composed of a first compound including a poly(fluorene biphenyl indole) polymer compound as a main chain and an aliphatic hydrocarbon group having a cation exchange group on a side chain of the polymer compound and an anion exchange membrane that is composed of a second compound represented by Formula 1 above; and bonding the hydrated proton exchange membrane and anion exchange membrane to each other by heating-press.

In one embodiment, the first compound may be prepared by including a first step of synthesizing the poly(fluorene biphenyl indole) polymer compound by polymerization of isatin, biphenyl and fluorene monomer in a presence of an organic solvent and a catalyst and a second step of introducing the aliphatic hydrocarbon group having the cation exchange group into the side chain of the polymer compound.

In one embodiment, the first compound may be represented by Formula 2 above.

In one embodiment, in the first step, an amount of the cation exchange group present in the first compound may be controlled by controlling a reaction molar ratio of the biphenyl and fluorene monomer to 1−x:x (x is 0.2 to 0.4).

In one embodiment, the cation exchange group may be selected from a sulfone group (—SO₃), a phosphoric acid group (—PO₄(−)), and a carboxy group (—COOH).

In one embodiment, the second compound having a structure represented by Formula 1-1 above may be prepared by including the steps of polymerizing a biphenyl monomer and a piperidone monomer in a presence of an organic solvent and a catalyst; and alkylating the polymerization reaction product.

Meanwhile, another embodiment of the present invention may provide a bipolar polymer electrolyte membrane for water electrolysis, which is prepared according to the method, and has a structure in which a proton exchange membrane that is composed of a first compound including a poly(fluorene biphenyl indole) polymer compound as a main chain and an aliphatic hydrocarbon group having a cation exchange group on a side chain of the polymer compound, and an anion exchange membrane that is composed of a second compound represented by the Formula 1 are bonded to each other.

### BRIEF DESCRIPTION OF THE DRAWINGS

FIG. 1 is a diagram schematically illustrating a mechanism of reaction of a water electrolysis electrode using a bipolar polymer electrolyte membrane for water electrolysis according to an embodiment of the present disclosure.

FIG. 2 is a diagram illustrating a synthesis process of sulfonated poly(fluorene biphenyl indole) and poly(arylene piperidinium), which are constituent materials of a proton exchange membrane and anion exchange membrane according to an embodiment of the present disclosure.

FIG. 3 shows ¹H-NMR spectra of SPFBI and PAP synthesized according to the present disclosure.

FIG. 4 is a graph showing an ion conductivity according to temperature of a proton exchange membrane prepared by varying the molar ratio of biphenyl and fluorene during polymer synthesis.

FIGS. 5A, 5B and 5C illustrate graphs of water electrolysis performance at 30° C., 50° C., and 70° C. of three bipolar membranes (BPM 60/40, BPM 70/30, and BPM 80/20) prepared in the present disclosure.

FIG. 6 is a TGA graph measured to identify the thermal stabilities of an anion exchange membrane (AEM), a proton exchange membrane (PEM), and a bipolar membrane (BPM) according to an embodiment of the present disclosure.

FIG. 7 is a graph showing the results of measuring the mechanical strengths of an anion exchange membrane (AEM), a proton exchange membrane (PEM), and a bipolar membrane (BPM) according to an embodiment of the present disclosure.

FIG. 8 shows an SEM image (A) of an interface that is a junction between a proton exchange membrane and anion exchange membrane of a bipolar membrane, and element mapping results (B) of the junction interface according to an embodiment of the present disclosure.

FIG. 9 shows the result of measuring the water uptake rate (A) and swelling rate (B) of a proton exchange membrane (PEM) having a backbone ratio of 80/20 according to an embodiment of the present disclosure, an anion exchange membrane (AEM), and a bipolar membrane (BPM) including the proton exchange membrane.

FIGS. 10A, 10B and 10C illustrate the weight losses of a proton exchange membrane, anion exchange membrane and bipolar membrane for 4 weeks in 4M H₂SO₄ and 4M KOH, measured to identify the chemical stabilities of the exchange membranes according to an embodiment of the present disclosure.

FIGS. 11A, 11B and 11C illustrate graphs of water electrolysis performance of an anion exchange membrane, a proton exchange membrane (PEM 80/20), and a bipolar membrane (BPM 80/20) by temperature according to an embodiment of the present disclosure.

FIG. 12 shows nyquist plots of electrochemical impedance spectroscopy (EIS) of a bipolar membrane. Specifically, (A) shows nyquist plots of a bipolar membrane (BPM) with a proton exchange membrane having a backbone ratio of 80/20, measured after setting 70° C. and a current density of 100 mA, and (B) shows nyquist plots of bipolar membranes with proton exchange membranes having backbone ratios of 80/20, 70/30, and 60/40, respectively, at 70° C. and 1000 mA.

### DETAILED DESCRIPTION

The terms used in the application are not intended to limit the present disclosure but are merely used to describe specific embodiments. A singular form may include a plural referent unless the context specifically indicates otherwise. In the application, it should be understood that the terms “include” or “have” indicates that a feature, a step, an operation, a component, a part or the combination thereof described in the specification is present, but does not exclude a possibility of presence or addition of one or more other features, steps, operations, components, parts or combinations, in advance.

If it is not contrarily defined, all terms used herein, including technological or scientific terms, have the same meaning as those generally understood by a person with ordinary skill in the art. Terms defined in generally used dictionary shall be construed to have meanings matching those in the context of a related art, and shall not be construed in ideal or excessively formal meanings unless they are clearly defined in the present application.

<Bipolar Polymer Electrolyte Membrane for Water Electrolysis>

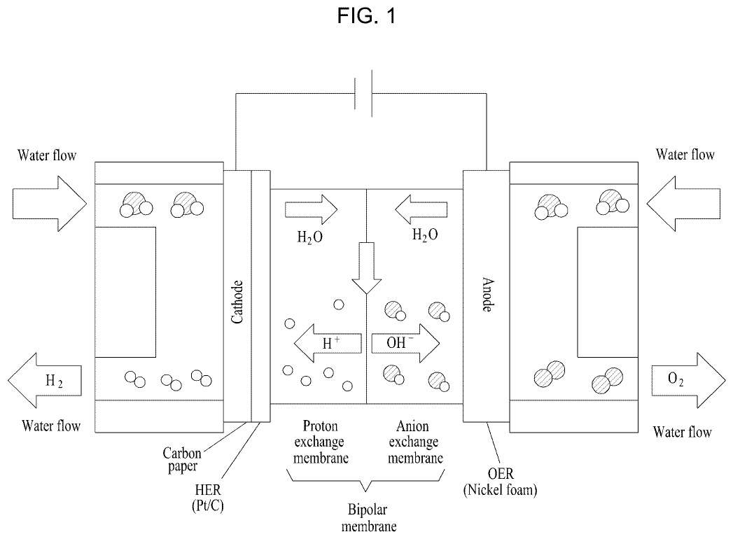

FIG. 1 is a diagram schematically illustrating a mechanism of reaction of a water electrolysis electrode using a bipolar polymer electrolyte membrane for water electrolysis according to an embodiment of the present disclosure.

Referring to FIG. 1, a bipolar polymer electrolyte membrane for water electrolysis of the present disclosure includes a proton exchange membrane and an anion exchange membrane, and the proton exchange membrane and the anion exchange membrane have structures bonded to each other.

Specifically, referring to FIG. 1, the bipolar polymer electrolyte membrane for water electrolysis of the present disclosure has a structure in which the proton exchange membrane, which is an acid medium in which a hydrogen evolution reaction (HER) occurs, and the anion exchange membrane, which is an alkaline medium in which an oxygen evolution (OER) occurs, combine to each other. Due to this structure, the existing voltage of 1.23 V required for water electrolysis can be reduced to about 0.4 V, and energy efficiency can be increased by selecting an appropriate electrode catalyst under acidic and basic conditions.

Meanwhile, for stable water electrolysis, the bipolar polymer electrolyte membrane must have high chemical stability. This is because the bipolar polymer electrolyte membrane in water electrolysis operates in strong acids and strong bases.

The proton exchange membrane of the present disclosure is composed of a first compound including a chemically stable poly(fluorene biphenyl indole) polymer compound as a main chain and an aliphatic hydrocarbon group having a cation exchange group on a side chain of the polymer compound, and thus, can have high chemical stability.

The poly(fluorene biphenyl indole) polymer compound is an ether-free bonding polymer and has excellent chemical, thermal, and mechanical stability because it does not contain an ether bond in its polymer structure. Therefore, the proton exchange membrane of the present disclosure can operate for water electrolysis for a long period of time.

In addition, in the first compound, the functional group of the aliphatic hydrocarbon group having the cation exchange group included in the side chain of the polymer compound acts as a catalyst while being weakly acidic, causing a water decomposition reaction in which water supplied to the interface of the bipolar polymer membrane is separated into hydrogen ions and hydroxide ions. In one embodiment, the aliphatic hydrocarbon group having the cation exchange group is not particularly limited, but may be an alkyl group having 3 to 10 carbon atoms having the cation exchange group at the terminal ends.

In one embodiment, the first compound may be represented by Formula 2 below.

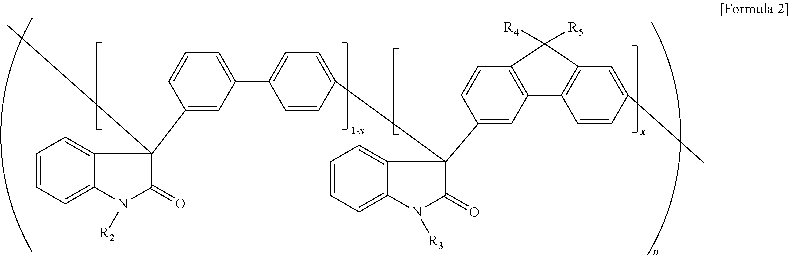

In Formula 2, R₂ to R₅ are alkyl groups having 3 to 10 carbon atoms having a cation exchange group at terminal ends, x is 0.2 to 0.4, and n is an integer from 70 to 90.

In one embodiment, the cation exchange group may be selected from a sulfone group (—SO₃), a phosphoric acid group (—PO₄(−)), and a carboxy group (—COOH), and is preferably a sulfone group (—SO₃), but is limited thereto. In addition, an amount of the cation exchange group in a total amount of the polymer may be controlled by appropriately controlling the molar ratio of the monomers in the process of synthesizing the first compound. This will be described later.

Specifically, the chemical structure of Formula 2 may have a group with three cation exchange groups per unit and a group with one cation exchange group per unit, and by controlling the molar ratio of these two groups, the amount of the cation exchange group in the polymer may be controlled. In addition, the ion conductivity of the proton exchange membrane varies depending on the molar ratio of the two groups, and by controlling the molar ratio of the polymer backbone to adjust the difference in ion conductivity with the anion exchange membrane, the ohmic resistance is reduced and the water electrolysis performance can be maximized.

In one embodiment, the first compound may be represented by Formula 2-1 below.

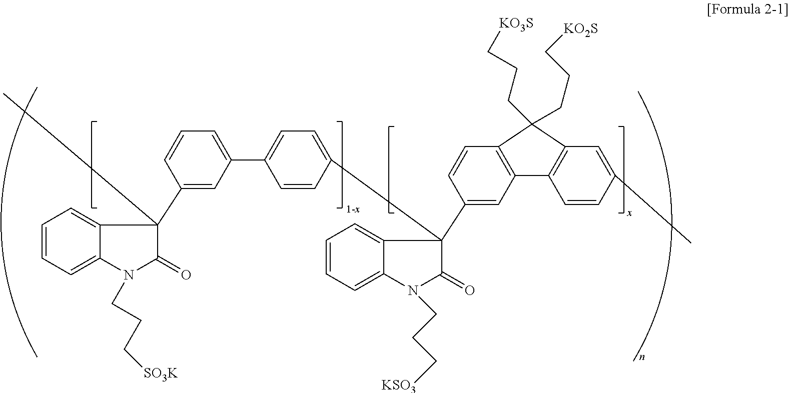

In Formula 2-1, x is 0.2 to 0.4; n is an integer from 70 to 90.

Meanwhile, the anion exchange membrane of the present disclosure may be composed of a second compound represented by Formula 1 below.

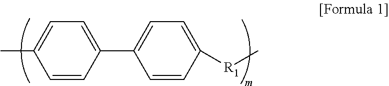

In Formula 1, R₁ is an anion exchange group, and m is an integer of 70 to 90.

Since the second compound is also based on an ether-free bonding polymer, it has excellent chemical, thermal, and mechanical stabilities. Therefore, the anion exchange membrane of the present disclosure can operate for water electrolysis for a long period of time.

In addition, in the second compound, the functional group of the anion exchange group introduced into the polymer compound has a weak base and acts as a catalyst, causing a water decomposition reaction in which water supplied to the interface of the bipolar polymer membrane is separated into hydrogen ions and hydroxide ions.

Specifically, as illustrated in FIG. 1, during the water electrolysis reaction, water supplied from both sides passes only through the inside of the proton exchange membrane and the anion exchange membrane and reaches the bonding interface. Here, the supply rate of water supplied to the junction interface, that is, mass transport, is influenced by the chemical structure of the bipolar polymer electrolyte membrane.

In addition, the functional groups introduced into the polymer act as a catalyst with a weak acid and a weak base, respectively, to cause a water decomposition reaction that separates the water supplied to the interface into hydrogen ions and hydroxide ions. That is, the water decomposition reaction rate is a value dependent on the introduced functional group in the chemical structure of the polymer.

On the other hand, the separated hydrogen ions and hydroxide ions reach the cathode and anode, respectively, and the speed at this time depends on the current density applied to the entire water electrolysis cell. In this case, when a high current density is applied, if the water supply rate and the water decomposition reaction rate do not catch up with the movement speed of hydrogen ions and hydroxide ions reaching the electrode, dehydration occurs at the interface of the bipolar polymer electrolyte membrane, resulting in permanent physical damage.

However, the proton exchange membrane of the present disclosure is composed of the first compound in which an aliphatic hydrocarbon group having a poly(fluorene biphenyl indole) polymer compound having no ether bond as a main chain and having a cation exchange group on a side chain of the polymer compound is introduced, and the anion exchange membrane is also composed of the second compound in which an anion exchange group is introduced into a polymer substrate that does not contain an ether bond. Therefore, chemical stability is excellent, and hydrogen production is possible even at a high current density.

Meanwhile, in one embodiment, the anion exchange group included in the second compound may include N-alkyl-N-methylpiperidinium, which is a piperidinium-based functional group, an imidazole-based functional group, a pyridinium-based functional group, a pyrrolidinium-based functional group, a morpholinium based functional group, a guanidinium based functional group, a quaternary phosphonium based functional group, crown-ether-metal complex, alkyl-side chain based quaternary ammonium, alkyl chain-space tetraalkylammonium, benzyl based side chain based quaternary ammonium, DABCO-based quaternary ammonium, quinuclidinium-based quaternary ammonium, a sulfonium-based functional group, a tertiary ammonium group, etc. More specifically, the anion exchange group may be selected from 1-dimethyl piperidinium, 1-methyl-piperidinium, 1,4-dimethyl-piperidinium, 1,3,5-trimethyl-piperidinium, 1,2,6-trimethylpiperidinium, benzimidazolium, and 1-butyl-1-methylpiperidinium. Preferably, the anion exchange group may be 1-butyl-1-methylpiperidinium. In this case, the second compound may be represented by Formula 1-1.

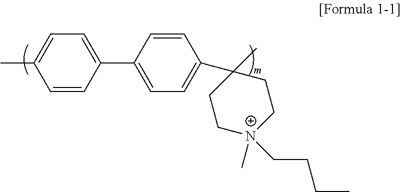

In Formula 1-1, m is an integer from 70 to 90.

The bipolar polymer electrolyte membrane according to the present disclosure has an effect of improving chemical stability and water electrolysis performance at the same time, since both the proton exchange membrane and the anion exchange membrane have an ether-free bonding polymer as a main chain and a pendant group including the cation exchange group each having a long aliphatic chain and the anion exchange group are introduced into the polymer.

Meanwhile, in the bipolar polymer electrolyte membrane of the present disclosure, the bonding portion of the proton exchange membrane and the anion exchange membrane may have a uniform interface. Such a uniform interface reduces the resistance required for water decomposition during water electrolysis. Therefore, the water electrolysis performance of the bipolar polymer electrolyte membrane of the present disclosure can be improved.

In addition, as described above, the bipolar polymer electrolyte membrane of the present disclosure can control the ion conductivity by controlling the amount of cation exchange groups introduced into the side chain of the proton exchange membrane, and thus minimizes the difference in ion conductivity between the proton exchange membrane and the anion exchange membrane. Accordingly, it is possible to reduce ohmic resistance and improve water electrolysis performance.

In one embodiment, the difference in ion conductivity between the proton exchange membrane and the anion exchange membrane may be 0.0001 S/cm to 0.01 S/cm.

In addition, when the bipolar polymer electrolyte membrane of the present disclosure is applied to water electrolysis, the voltage required for water decomposition may be reduced to 0.4 V (about 1.23 V in the conventional case) under the same conditions, thereby increasing energy efficiency.

<A Method for Manufacturing a Bipolar Polymer Electrolyte Membrane for Water Electrolysis>

A method for manufacturing a bipolar polymer electrolyte membrane for water electrolysis of the present disclosure may comprise the steps of hydrating a proton exchange membrane that is composed of a first compound including a poly(fluorene biphenyl indole) polymer compound as a main chain and an aliphatic hydrocarbon group having a cation exchange group on a side chain of the polymer compound and an anion exchange membrane that is composed of a second compound represented by Formula 1 above, and bonding the hydrated proton exchange membrane and anion exchange membrane to each other by heating-press.

First, the step of hydrating a proton exchange membrane that is composed of a first compound including a poly(fluorene biphenyl indole) polymer compound as a main chain and an aliphatic hydrocarbon group having a cation exchange group on a side chain of the polymer compound and an anion exchange membrane that is composed of a second compound represented by Formula 1 above is performed.

In one embodiment, the first compound may be prepared by including a first step of synthesizing the poly(fluorene biphenyl indole) polymer compound by polymerization of isatin, biphenyl and fluorene monomer in the presence of an organic solvent and a catalyst, and a second step of introducing the aliphatic hydrocarbon group having the cation exchange group into the side chain of the polymer compound.

In the first step, an amount of the cation exchange group present in the first compound may be controlled by controlling a reaction molar ratio of the biphenyl and fluorene monomer to 1−x:x (x is 0.2 to 0.4).

In one embodiment, the first compound may have a structure represented by Formula 2 below.

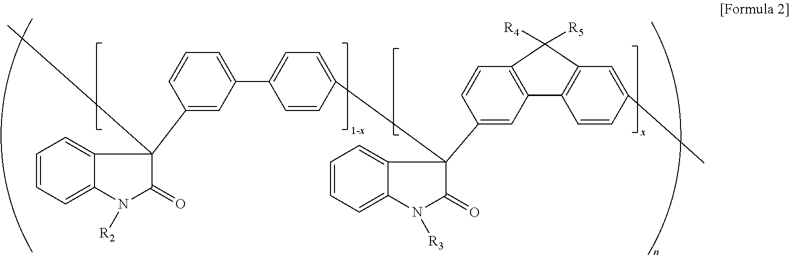

In Formula 2, R₂ to R₅ are alkyl groups having 3 to 10 carbon atoms having the cation exchange group at terminal ends, x is 0.2 to 0.4, and n is an integer from 70 to 90.

Specifically, the polymer structure represented by Formula 2 may have a group with three cation exchange groups per unit and a group with one cation exchange group per unit. The ratio of these units may be controlled by controlling the molar ratio of the biphenyl and fluorene to 1−x:x (x is 0.2 to 0.4) during synthesis to control the amount of cation exchange groups in the polymer.

Here, the cation exchange group may be selected from a sulfone group (—SO₃), a phosphoric acid group (—PO₄(−)), and a carboxy group (—COOH), and may preferably be a sulfone group (—SO₃).

Meanwhile, in the first step, the organic solvent used may be dichloromethane, and the catalyst may include trifluoroacetic acid and trifluoromethanesulfonic acid, but is not limited thereto.

The second step is the step of introducing a cationic functional group into the side chain of the polymer prepared in the first step. Depending on the type of cationic functional group, a cationic functional group may be introduced into the side chain of the polymer through a commonly employed method.

Meanwhile, the second compound may have a structure represented by Chemical Formula 1-1 below.

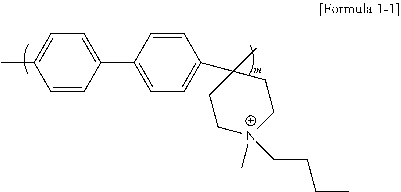

In Formula 1-1, m is an integer from 70 to 90.

When the second compound has a structure represented by Formula 1-1, the second compound may be prepared by including the steps of polymerizing a biphenyl monomer and a piperidone monomer in the presence of an organic solvent and a catalyst, and alkylating the polymerization reaction product.

In one embodiment, the organic solvent used in the polymerization step may be dichloromethane, and the catalyst may be trifluoroacetic acid and trifluoromethanesulfonic acid, but is not limited thereto.

In one embodiment, the alkylating step may be performed by adding an alkylating agent to the polymerization reaction product, for example, C₄H₃I may be used as the alkylating agent.

On the other hand, the proton exchange membrane and the anion exchange membrane may be prepared by casting a solution in which the first compound and the second compound are dissolved in an organic solvent, respectively, and then drying the solution at a temperature of about 60 to 100° C. for about 24 hours. The proton exchange membrane and the anion exchange membrane may be hydrated for adhesion.

Next, the step of bonding the hydrated proton exchange membrane and anion exchange membrane to each other by heating-press is performed.

In one embodiment, the proton exchange membrane and the anion exchange membrane may be bonded by applying high temperature and high pressure at about 60 to 100° C. and 8 to 15 MPa using a heating-press.

On the other hand, another embodiment of the present disclosure relates to a bipolar polymer electrolyte membrane for water electrolysis having a structure in which a proton exchange membrane that is composed of a first compound including a poly(fluorene biphenyl indole) polymer compound as a main chain and an aliphatic hydrocarbon group having a cation exchange group on the side chain of the polymer compound prepared by the above method and an anion exchange membrane composed of a second compound represented by Formula 1 above are bonded to each other.

Hereinafter, the bipolar polymer electrolyte membrane for water electrolysis and the manufacturing method thereof of the present disclosure will be described in more detail through specific examples and comparative examples. However, the embodiments of the present disclosure are merely some embodiments of the present disclosure, and the scope of the present disclosure is not limited to the following examples.

### Example 1: Preparation of Proton Exchange Membrane (PEM)

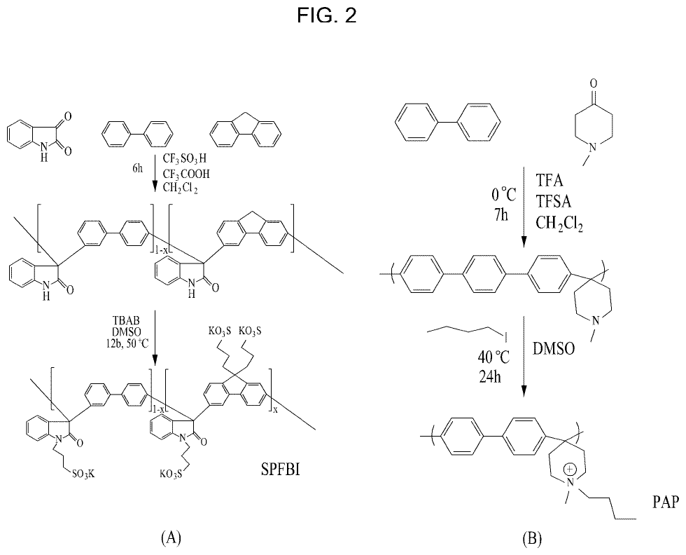

1-1. Poly(Fluorene Biphenyl Indole), PFBI (See (A) in FIG. 2)

2 g of isatin, biphenyl, and fluorene were added in a three-necked flask. Here, an amount of the cation exchange group in the polymer may be controlled by changing the molar ratio of biphenyl and fluorene.

As a solvent, 15 ml of dichloromethane was put and stirred under nitrogen conditions until the three monomers were completely dissolved. After the stirring is over, 10 ml of trifluoroacetic acid and 15 ml of trifluoromethanesulfonic acid were slowly dropped into the three-necked flask while maintaining the temperature at 0 to 5° C. In this case, the color of the stirred solution changes from orange to dark purple. This means that trifluoroacetic acid, a super acid, reacted perfectly under nitrogen conditions, and it was confirmed that not only the color but also the viscosity increased during the reaction time.

After 6 hours, the solution in the three-necked flask was slowly precipitated in methanol. Subsequently, the polymer precipitated in methanol was precipitated again in distilled water (DI water) to remove impurities, and then dried at 80° C. for 24 hours. The yield of PFBI at this time is 93 to 96%.

1-2. Sulfonated Poly(Fluorene Biphenyl Indole), SPFBI

3 g of PFBI and 0.116 g of tetrabutylammonium bromde (TBAB) were dissolved in 80 ml of DMSO. The temperature at this time was maintained at 60° C. The dissolved solution was stirred again in a three-necked flask under nitrogen conditions to remove oxygen gas present in the solution.

After slowly injecting 4 ml of 50 weight by % KOH with a syringe, 1,3-propane sultone was added. The color of the polymer solution changes from pale yellow to dark orange. Thereafter, when stirring was performed at 60° C. for 12 hours under nitrogen conditions, the color of the polymer solution changed to dark green. The synthesized polymer solution was purified by precipitation in methanol for 12 hours, and the color of the solution changed to yellow. The precipitated polymer was sequentially precipitated in distilled water (DI water) and isopropanol to remove impurities, and then dried at 80° C. for 24 hours. The yield of SPFBI at this time is 85 to 88%. In addition, the molecular weight of the synthesized SPFBI is about 60,000 (M of repeat unit).

1-3. Manufacture of SPFBI Proton Exchange Membrane

A solution obtained by dissolving 0.3 g of SPFBI in 7 ml of DMSO at room temperature for 24 hours was cast in a Petri dish and dried in an oven at 80° C. for 24 hours to obtain a proton exchange membrane. Thereafter, after immersing the proton exchange membrane in 2M HCl for 24 hours, it was maintained in distilled water (DI water) for another 24 hours.

### Example 2: Preparation of Anion Exchange Membrane (AEM)

2-1. Poly(Arylene Piperidinium), PAP Precursor (See (B) in FIG. 2)

In a three-necked flask, 3.02 g (0.02 mole) of biphenyl and 15 ml of dichloromethane were stirred. Stirring was carried out under room temperature (RT) and nitrogen conditions. After the temperature dropped to 0° C., 2.11 g (0.025 mol) of N-methyl-4-piperidone was additionally added to the three-necked flask and stirred for 30 minutes under nitrogen conditions. Thereafter, 2 ml of trifluoroacetic acid and 15 ml of trifluoromethanesulfonic acid were slowly dropped into the stirred solution. The reacted solution changed from yellow to dark blue. After stirring for 24 hours, the solution with increased viscosity was precipitated in 1M KOH. The color of the precipitated polymer was white. Thereafter, the polymer was precipitated in distilled water (DI water) to remove impurities, and then dried at 80° C. for 24 hours. The yield at this time is 98%.

2-2. Manufacture of PAP Anion Exchange Membrane

0.2 g of the polymer synthesized in 2-1, 10 ml of DMSO, and 500 μL of C₄H₃I were stirred at 50° C. for 24 hours to synthesize PAP (molecular weight of about 60,000 (M of repeat unit)). Thereafter, the yellow homogeneous solution was cast in a petri dish, and then dried in an oven at 80° C. for 20 hours. Then, it was further dried at 120° C. for 4 hours. Thereafter, the obtained membrane was immersed in 2M KOH for 24 hours and maintained in distilled water (DI water) for 24 hours.

### Example 3: Preparation of Bipolar Membrane

In a state where the proton exchange membrane (SPFBI) and anion exchange membrane (PAP) in a hydrated state were overlapped, high-temperature and high-pressure were applied at 80° C. and 10 MPa for 3 minutes using a heating-press. The obtained bipolar membrane was then stored in distilled water.

<Identification of SPFBI and PAP Synthesis>

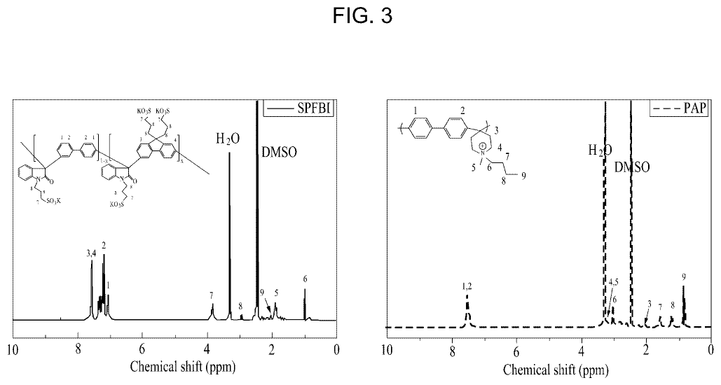

The synthesis of SPFBI and PAP was identified through the ¹H-NMR spectrum in FIG. 3.

Referring to FIG. 3, the benzene ring in the main chain of SPFBI can be identified as a peak between 7.85 ppm and 7 ppm. In addition, functional group was identified through peaks of 3.83 ppm, 3.41 ppm, 2.00 ppm, 1.87 ppm, and 1.61 ppm.

The benzene ring in the main chain of PAP can also be identified as a peak between 7.38 ppm and 7.29 ppm. In addition, the functional group was confirmed through peaks of 3.30 ppm, 3.29 ppm, 3.24 ppm, 2.11 ppm, 1.73 ppm, 1.31 ppm, and 0.90 ppm.

<Evaluation of Ion Conductivity of Proton Exchange Membrane and Anion Exchange Membrane>

The ionic conductivity of SPFBI used as a proton exchange membrane (PEM) can be controlled by changing the ratio of groups with many sulfonic groups and groups with few functional groups. Specifically, referring the chemical structure of SPFBI shown in FIG. 3, SPFBI has a group with three sulfone groups attached to one unit and a group with one sulfone group attached to one unit. The ratio of these units can be controlled by controlling the molar ratio of biphenyl and fluorene to 1−x:x (x is 0.2 to 0.4) during synthesis to control the ratio of the sulfone groups in the polymer. In the present disclosure, three proton exchange membranes (named PEM 80/20, 70/30, and 60/40) prepared by setting x to 0.2, 0.3, and 0.4 were prepared.

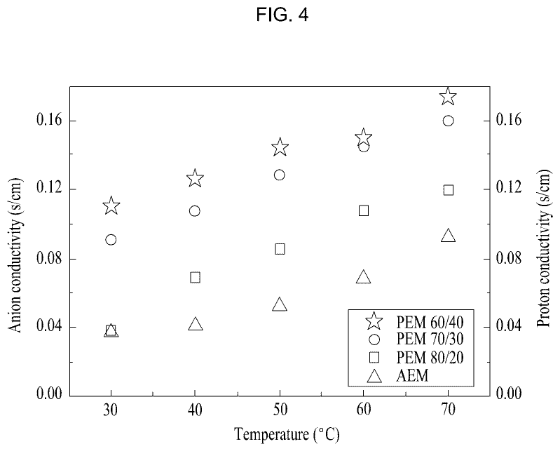

FIG. 4 is a graph showing the ion conductivities according to the temperature of three proton exchange membranes prepared by varying the molar ratio of biphenyl and fluorene during polymer synthesis.

Referring to FIG. 4, PEM 60/40 having the high molar ratio of the backbone with three sulfone groups per unit showed the highest ionic conductivity, and PEM 80/20 having the lowest molar ratio of the backbone with three sulfone groups per unit showed the lowest ionic conductivity among the proton exchange membranes.

On the other hand, it can be seen that the anion exchange membrane (AEM) has similar ionic conductivity (based on 30° C., PEM 80/20: 0.03793 S/cm, PEM 70/30: 0.09086 S/cm, PEM 60/40: 0.11043 S/cm, AEM: 0.03707 S/cm) to PEM 80/20 at a temperature of 30° C. As the temperature rises, the ionic conductivities between the PEM 80/20 and the anion exchange membrane gradually show a difference.

Based on the ion conductivity graph in FIG. 4, three bipolar polymer electrolyte membranes composed of three proton exchange membranes having different sulfonation degrees and anion exchange membranes were prepared. Here, the bipolar membrane made of PEM 80/20 and AEM is named BPM 80/20, the bipolar membrane made of PEM 70/30 and AEM is named BPM 70/30, and the bipolar membrane made of PEM 60/40 and AEM is named BPM 60/40.

<Evaluation of Water Electrolysis Performance of Bipolar Polymer Electrolyte Membrane by Temperature>

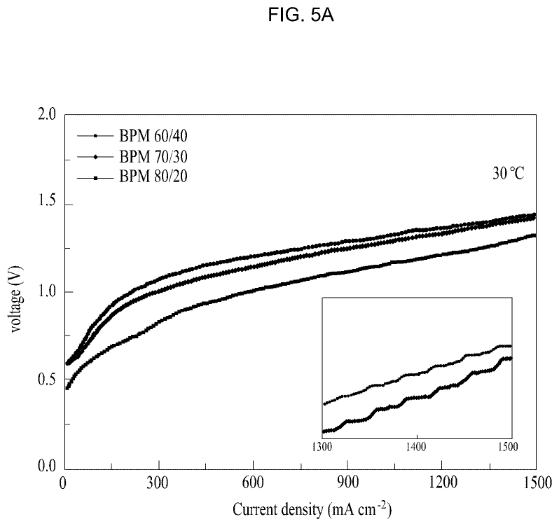

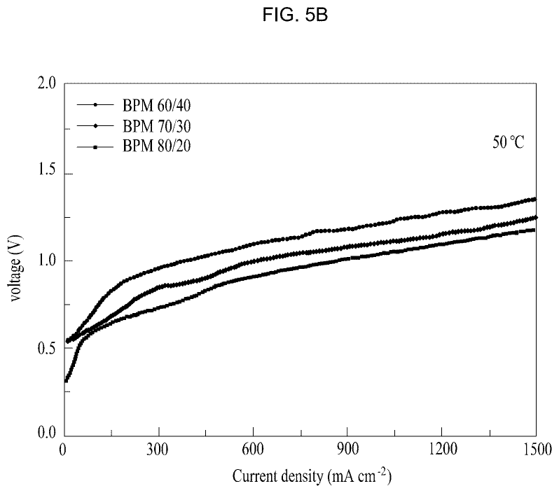

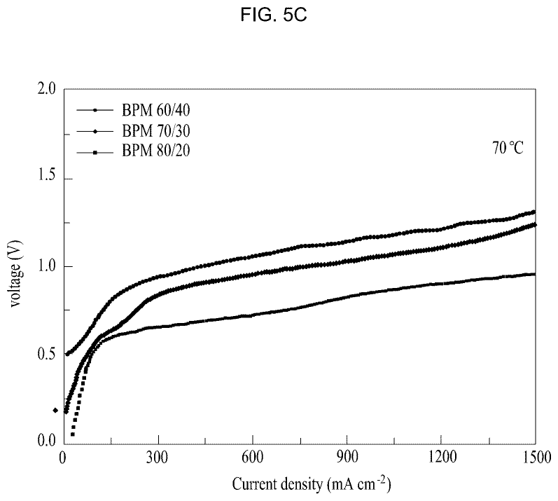

FIGS. 5A, 5B and 5C illustrate graphs of water electrolysis performance at 30° C., 50° C., and 70° C. of three bipolar membranes (BPM 60/40, BPM 70/30, and BPM 80/20) prepared in the present disclosure.

It can be seen that BPM 60/40, BPM 70/30, and BPM 80/20 operate stably even at a high current density of 1500 mA cm·2 under three different temperature conditions. In addition, the voltage across the entire water electrolysis cell is lower than 1.5 V for all three bipolar membranes, and thus, it can be confirmed that energy-efficient hydrogen production is possible.

On the other hand, referring to FIGS. 5A, 5B and 5C, as the temperature increases, the voltage of all three bipolar membranes shows a graph tendency to decrease. When comparing BPM 60/40, BPM 70/30, and BPM 80/20, it can be confirmed that BPM 60/40 has the lowest energy efficiency and BPM 80/20 has the highest energy efficiency. Therefore, only BPM 80/20, which has the highest energy efficiency, was used in all subsequent experiments to identify the physical properties of the membrane.

<Evaluation of Thermal Stability of Anion Exchange Membrane, Proton Exchange Membrane, and Bipolar Membrane>

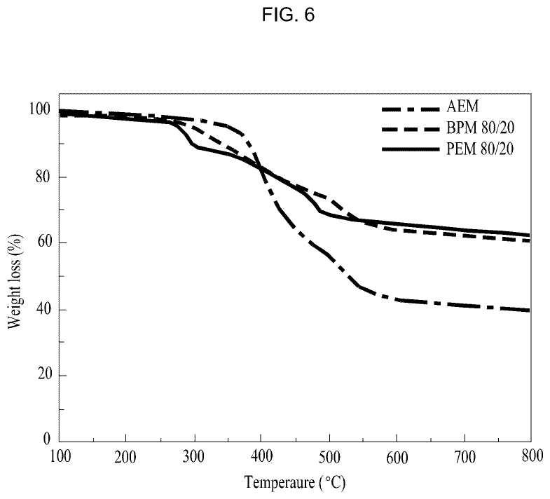

FIG. 6 is a TGA graph measured to identify the thermal stabilities of an anion exchange membrane (AEM), a proton exchange membrane (PEM), and a bipolar membrane (BPM).

It was confirmed that the primary weight loss in which the functional groups were separated from the main chain occurred at 350° C. for the anion exchange membrane, at 300° C. for the proton exchange membrane, and at 298° C. for the bipolar membrane. In addition, the secondary weight loss due to breakage of the main chain occurred at 490° C. for the anion exchange membrane, 463° C. for the proton exchange membrane, and 460° C. for the bipolar membrane. From these results, it can be confirmed that all three films are thermally stable up to 298° C.

<Evaluation of Mechanical Strength of Anion Exchange Membrane, Proton Exchange Membrane, and Bipolar Membrane>

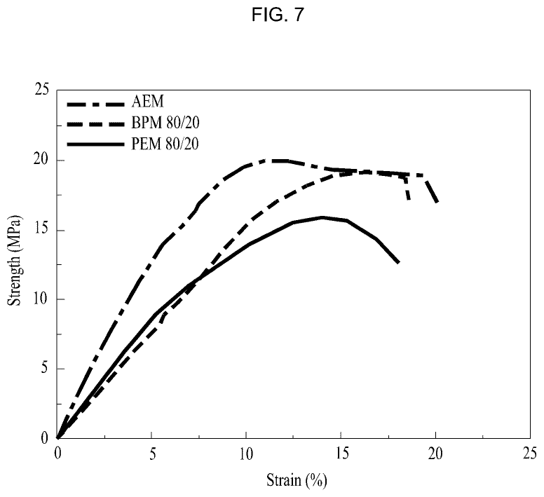

FIG. 7 is a graph showing the results of measuring the mechanical strengths of an anion exchange membrane (AEM), a proton exchange membrane (PEM), and a bipolar membrane (BPM). In this case, since water electrolysis is operated in a hydrated state, the mechanical strength measurement conditions were measured in a hydrated state rather than a dry state.

Referring to FIG. 7, the elongation of the anion exchange membrane (AEM) was measured to 11.65%, the elongation of the proton exchange membrane (PEM) was measured to 20.04%, and the elongation of the bipolar membrane (BPM) was measured to 16.25%. Also, the tensile strength of the anion exchange membrane (AEM) was measured to 20.00 Mpa, the tensile strength of the proton exchange membrane (PEM) was measured to 17.10 Mpa, and the tensile strength of the bipolar membrane (BPM) was measured to 19.15 Mpa.

Among the three membranes, it can be seen that the proton exchange membrane has the lowest tensile strength, and the anion exchange membrane has the lowest elongation. This is related to the water uptake rate of the membrane, because the water absorbed into the membrane acts as a plasticizer and lowers the mechanical strength. Therefore, the proton exchange membrane having the highest water uptake has the lowest tensile strength.

On the other hand, the bipolar membrane has a thickness of 120 μm, unlike the proton exchange membrane (thickness 60 μm) and anion exchange membrane (thickness 60 μm). As a result, the bipolar membrane showed intermediate values in tensile strength and elongation among the three membranes due to the effect of the thicker thickness, even though the proton exchange membrane with high water uptake was one of the components.

<Identification of Morphology of Bipolar Membrane>

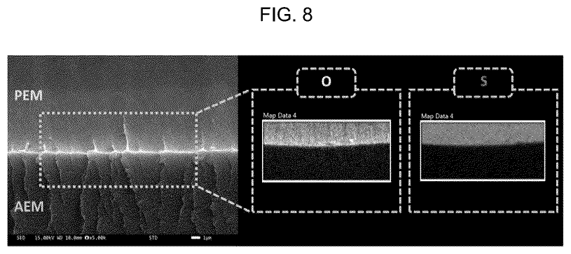

The interface, which is the junction between the proton exchange membrane and anion exchange membrane of the bipolar membrane, was observed through SEM and shown in FIG. 8. Referring to FIG. 8, it can be confirmed that the two exchange membranes are uniformly bonded in a state in which no voids exist.

Since the binding structure of the bipolar membrane affects the formation of the electric field required for water decomposition, it means that the more uniform the interface, the smaller the water composition resistance. Therefore, it can be seen that the bipolar membrane of the present disclosure has an interface suitable for water decomposition.

In addition, elemental mapping was additionally measured on cross-section images of the junction.

As shown in FIG. 8, an upper layer is the proton exchange membrane and a lower layer is the anion exchange membrane, and the constituent elements of the functional group of the proton exchange membrane are S, O, K, and N, and the constituent elements of the functional group of the anion exchange membrane is N. In order to distinguish the two exchange membranes, elemental mapping of O and S was identified.

<Evaluation of Water Uptake and Swelling Rate of Anion Exchange Membrane, Proton Exchange Membrane, and Bipolar Membrane>

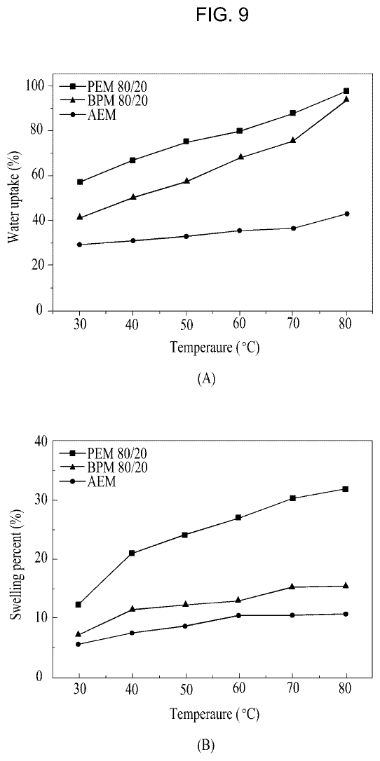

FIG. 9 shows the result of measuring the water uptake rate (A) and swelling rate (B) of three exchange membranes, i.e., PEM 80/20 among the proton exchange membrane (PEM), the anion exchange membrane (AEM), and the bipolar membrane (BPM) including the BPM 80/20.

Referring to FIG. 9, the proton exchange membrane has the highest water uptake rate and swelling rate because sulfur in the functional group is hydrophilic. Therefore, since the bipolar membrane also has a sulfur-containing proton exchange membrane as a component, it was confirmed that the water uptake graph varies depending on the graph of the proton exchange membrane.

In the case of the swelling rate (B), it was confirmed that the graph of the bipolar membrane varied depending on the graph of the anion exchange membrane. This is because the proton exchange membrane and the anion exchange membrane share one dimension at the interface of the bipolar membrane. It was confirmed that the value of the bipolar membrane depends on the swelling rate of the anion exchange membrane, which is a small value, even if the proton exchange membrane is greatly swollen.

<Identification of Chemical Stabilities of Proton Exchange Membrane, Anion Exchange Membrane, and Bipolar Membrane for 4 Weeks>

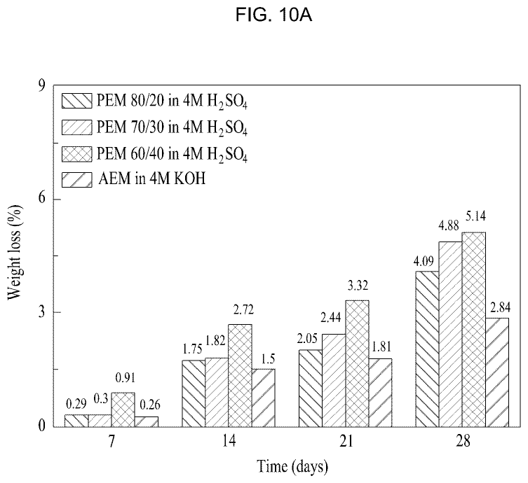

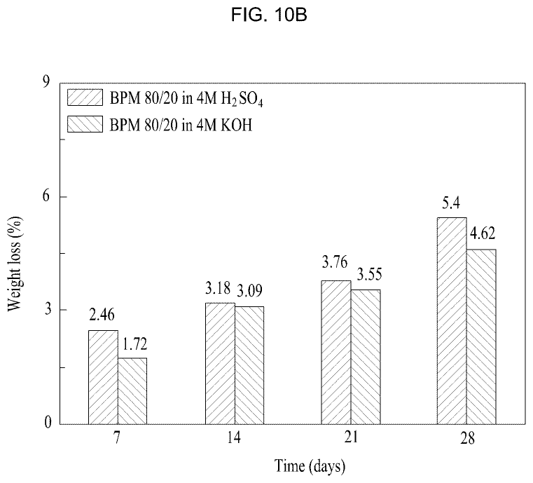

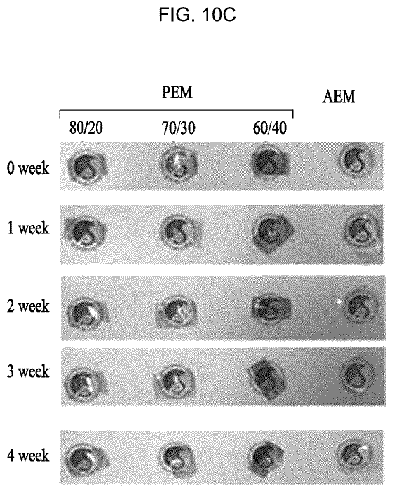

FIGS. 10A, 10B and 10C illustrate the weight losses of a proton exchange membrane, anion exchange membrane and bipolar membrane for 4 weeks in 4M H₂SO₄ and 4M KOH, measured to identify the chemical stabilities of the exchange membranes. The experiment was performed at room temperature (RT).

FIG. 10A is a graph of weight losses for 4 weeks when the proton exchange membranes, PEM 80/20, PEM 70/30, PEM 60/40 and the AEM were immersed in 4M H₂SO₄ and 4M KOH, respectively. The results showed that at the fourth week, the weight losses were 4.09%, 4.88%, 5.14%, and 2.84% in that order.

FIG. 10B is a graph of weight losses for 4 weeks when BPM 80/20 was immersed in 4M H₂SO₄ and 4M KOH. As a result, after 4 weeks, the weight loss was 5.4% in 4M H₂SO₄ and 4.62% in 4M KOH.

FIG. 10C is a photograph after measuring the weight losses of the four exchange membranes at weeks 1, 2, 3, and 4. It was confirmed that there was no crack or damage to the exchange membranes visible in the photo, and it was confirmed that the exchange membranes were chemically stable for 4 weeks.

<Water Electrolysis Performance of Anion Exchange Membrane, Proton Exchange Membrane, and Bipolar Membrane by Temperature>

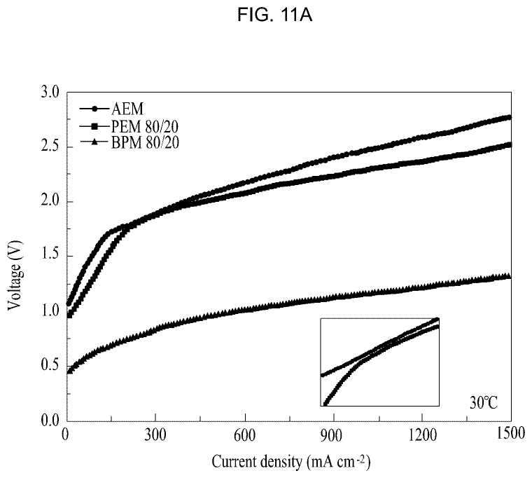

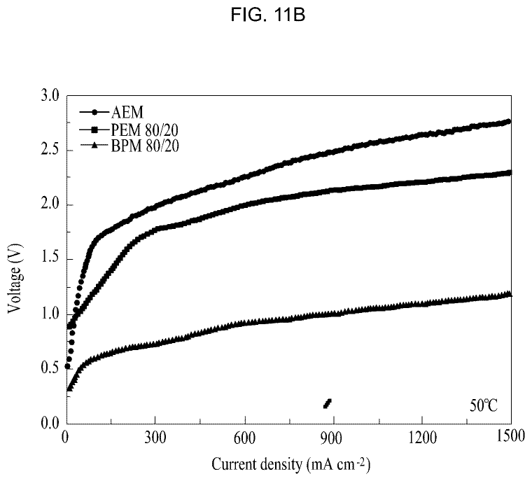

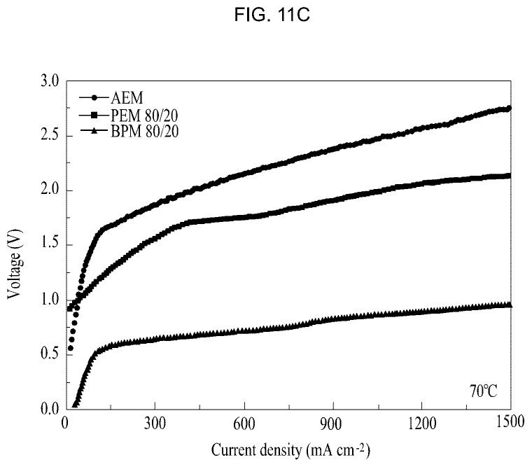

FIGS. 11A, 11B and 11C illustrate graphs of water electrolysis performance of an anion exchange membrane, a proton exchange membrane (PEM 80/20), and a bipolar membrane (BPM 80/20) by temperature.

Referring to FIGS. 11A, 11B and 11C, it was confirmed that among the three exchange membranes, the anion exchange membrane had the lowest performance and the bipolar membrane had the highest performance in order at all temperature conditions of 30° C., 50° C., and 70° C. This can be seen as a difference caused by the slowest reaction rate occurring at the electrodes of the proton exchange membrane and anion exchange membrane determining the overall reaction rate.

The slowest reaction in the anion exchange membrane is the hydrogen evolution reaction (HER) that occurs in base media. In addition, the slowest reaction in the proton exchange membrane is an oxygen evolution reaction (OER) that occurs in an acid medium. Additionally, since the proton exchange membrane used platinum catalyst on both electrodes, but the anion exchange membrane used nickel foam on both sides, the electrode catalyst can also be seen as a factor affecting the overall water electrolysis performance.

Specifically, FIG. 11A is a water electrolysis performance graph measured at 30° C., and shows that the anion exchange membrane and the proton exchange membrane showed similar performance in the range of 200 mA to 450 mA. This seems to be because the PEM 80/20 and the anion exchange membrane had similar ion conductivities at 30° C. as shown in FIG. 4.

<Nyqist Plots of Bipolar Membrane>

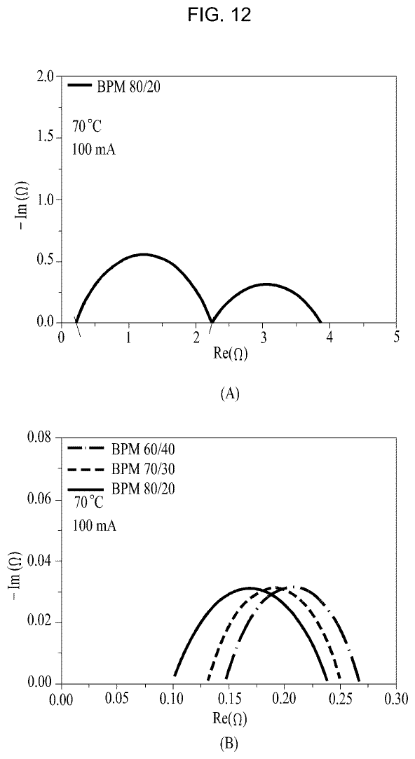

FIG. 12 is nyquist plots of electrochemical impedance spectroscopy (EIS) of a bipolar membrane. The active area of the cell is 9 cm², and the measurement was conducted after setting to the galvanostatic mode. (A) is a graph of BPM 80/20 measured after setting 70° C. and a current density of 100 mA.

In (C) in FIG. 5, it can be seen that the polarization curve of BPM 80/20 shifts from an electrochemical reaction to a kinetic reaction starting at 103 mA. That is, the transition state from the water dissociation reaction (WDR) at the interface of the bipolar membrane to the hydrogen evolution reaction (HER) generated at the electrode can be confirmed. Therefore, if the current density is set to before/after 103 mA, the resistance applied to the water decomposition reaction and hydrogen generation reaction can be sequentially identified. In the polarization curve of BPM 70/30 and BPM 60/40, starting at 155 mA and 164 mA, the hydrogen generation reaction occurs sequentially in the water decomposition reaction. Therefore, in BPM 80/20, at a current density of 100 mA, the mass transport of hydrogen ions and hydroxide ions dissociated from water to the proton exchange membrane and the anion exchange membrane is not sufficient to occur. For this reason, the nyquist plot of BPM 70/30 and BPM 60/40 cannot be measured at 100 mA.

(B) is nyquist plots of BPM 80/20, BPM 70/30 and BPM 60/40 at 70° C. and 1000 mA. Referring to (C) in FIG. 5, it can be seen that all three bipolar membranes are in the hydrogen evolution reaction (HER) region at 1000 mA. On the other hand, in (B), it can be seen that the ohmic resistance, which means the x-intercept in the high frequency region, is dominant at 1000 mA. The ohmic resistance is determined by the reaction occurring inside the bipolar membrane, and can be regarded as the resistance caused by the water decomposition reaction at the interface.

Through this, it can be experimentally confirmed that BPM 80/20, which has the smallest difference in ion conductivity between the proton exchange membrane and the anion exchange membrane, has the lowest resistance, and thus shows the highest water electrolysis performance among the three bipolar membranes.

According to the present disclosure, since both the proton exchange membrane and the anion exchange membrane have an ether-free bonding polymer as a main chain and a pendant group including the cation exchange group each having a long aliphatic chain and the anion exchange group are introduced into the polymer, the chemical stability and water electrolysis performance of the bipolar polymer electrolyte membrane for water electrolysis can be improved.

In addition, since there is no significant difference in ion conductivities between the proton exchange membrane and anion exchange membrane constituting the bipolar polymer electrolyte membrane, water electrolysis performance can be improved.

Specifically, compared to the case of using the conventional proton exchange membrane and anion exchange membrane alone, when the bipolar polymer electrolyte membrane of the present disclosure is applied to water electrolysis, the voltage can be reduced to 0.4 V (about 1.23 V in the conventional case) under the same conditions, thereby increasing energy efficiency.

In addition, the bipolar polymer electrolyte membrane for water electrolysis prepared in the present disclosure uses inexpensive hydrocarbon-based polymers, so the production cost can be reduced with inexpensive raw materials. Further, chemical stability is achieved because the polymer main chain does not contain ether bonding, so that it has the advantage of being able to operate water electrolysis for a long time.

The present disclosure has been described with reference to the preferred embodiments. However, it will be appreciated by those skilled in the art that various modifications and changes of the present disclosure can be made without departing from the spirit and the scope of the present disclosure which are defined in the appended claims and their equivalents.

What is claimed is:

1. A bipolar polymer electrolyte membrane for water electrolysis, comprising:
a proton exchange membrane that is composed of a first compound including a poly(fluorene biphenyl indole) polymer compound as a main chain and an aliphatic hydrocarbon group having a cation exchange group on a side chain of the polymer compound; and
an anion exchange membrane that is composed of a second compound represented by Formula 1 below,
wherein the proton exchange membrane and the anion exchange membrane have structures bonded to each other: 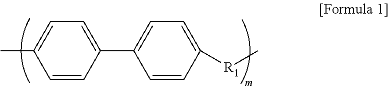
in Formula 1, R₁ is the anion exchange group and m is an integer from 70 to 90.

2. The bipolar polymer electrolyte membrane of claim 1, wherein the first compound is represented by Formula 2 below: 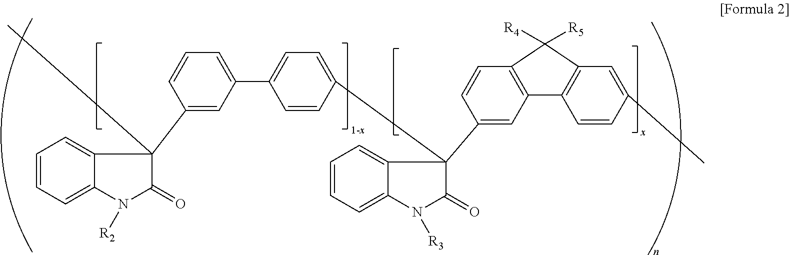
in Formula 2, R₂ to R₅ are alkyl groups having 3 to 10 carbon atoms having the cation exchange group at terminal ends, x is 0.2 to 0.4, and n is an integer from 70 to 90.

3. The bipolar polymer electrolyte membrane of claim 1, wherein the cation exchange group is selected from a sulfone group (—SO₃), a phosphoric acid group (—PO₄(−)) and a carboxy group (—COOH).

4. The bipolar polymer electrolyte membrane of claim 1, wherein the cation exchange group is the sulfone group (—SO₃).

5. The bipolar polymer electrolyte membrane of claim 1, wherein the first compound is represented by Formula 2-1 below: 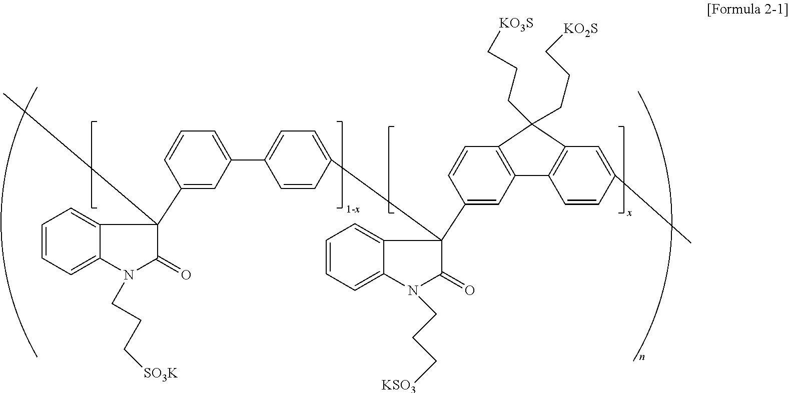
in Formula 2-1, x is 0.2 to 0.4; n is an integer from 70 to 90.

6. The bipolar polymer electrolyte membrane of claim 1, wherein the anion exchange group is selected from 1-dimethyl piperidinium, 1-methyl-piperidinium, 1,4-dimethyl-piperidinium, 1,3,5-trimethyl-piperidinium, 1,2,6-trimethylpiperidinium, benzimidazolium, and 1-butyl-1-methylpiperidinium.

7. The bipolar polymer electrolyte membrane of claim 1, wherein the second compound is represented by Formula 1-1 below: 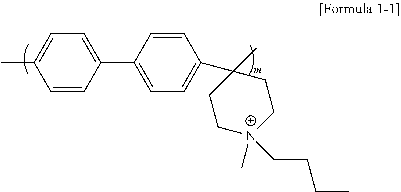
in Formula 1-1, m is an integer from 70 to 90.

8. The bipolar polymer electrolyte membrane of claim 1, wherein a bonding portion of the proton exchange membrane and the anion exchange membrane has a uniform interface.

9. The bipolar polymer electrolyte membrane of claim 1, wherein a difference in ion conductivity between the proton exchange membrane and the anion exchange membrane is 0.0001 S/cm to 0.01 S/cm.

10. The bipolar polymer electrolyte membrane of claim 2, wherein the cation exchange group is selected from a sulfone group (—SO₃), a phosphoric acid group (—PO₄(−)) and a carboxy group (—COOH).

11. The bipolar polymer electrolyte membrane of claim 2, wherein the cation exchange group is the sulfone group (—SO₃).

12. A method for manufacturing a bipolar polymer electrolyte membrane for water electrolysis of the present disclosure, the method comprising the steps of:
hydrating a proton exchange membrane that is composed of a first compound including a poly(fluorene biphenyl indole) polymer compound as a main chain and an aliphatic hydrocarbon group having a cation exchange group on a side chain of the polymer compound and an anion exchange membrane that is composed of a second compound represented by Formula 1 below; and
bonding the hydrated proton exchange membrane and anion exchange membrane to each other by heating-press: 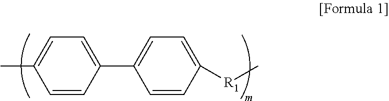
in Formula 1, R₁ is the anion exchange group and m is an integer from 70 to 90.

13. The method of claim 12, wherein the first compound is prepared by including:
a first step of synthesizing the poly(fluorene biphenyl indole) polymer compound by polymerization of isatin, biphenyl and fluorene monomer in a presence of an organic solvent and a catalyst; and
a second step of introducing the aliphatic hydrocarbon group having the cation exchange group into the side chain of the polymer compound.

14. The method of claim 13, wherein the first compound is represented by Formula 2 below: 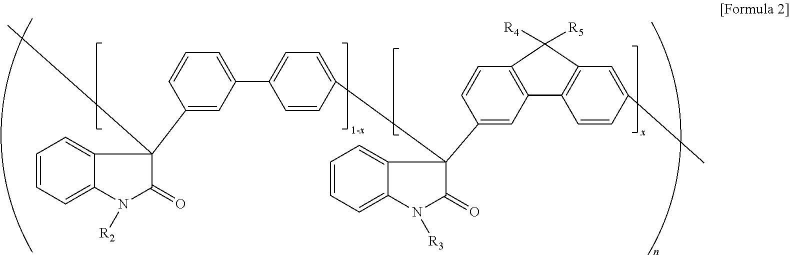
in Formula 2, R₂ to R₅ are alkyl groups having 3 to 10 carbon atoms having the cation exchange group at terminal ends, x is 0.2 to 0.4, and n is an integer from 70 to 90.

15. The method of claim 14, wherein in the first step, a reaction molar ratio of the biphenyl and fluorene monomer is controlled to 1−x:x (x is 0.2 to 0.4).

16. The method of claim 14, wherein the cation exchange group is selected from a sulfone group (—SO₃), a phosphoric acid group (—PO₄(−)), and a carboxy group (—COOH).

17. The method of claim 12, wherein the second compound has a structure represented by Formula 1-1 below: 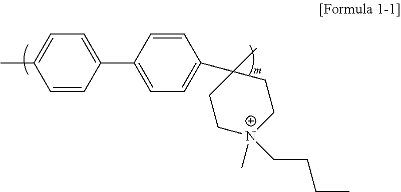
in Formula 1-1, m is an integer from 70 to 90.

18. The method of claim 17, wherein the second compound having a structure represented by the Formula 1-1 is prepared by including the steps of:
polymerizing a biphenyl monomer and a piperidone monomer in a presence of an organic solvent and a catalyst; and
alkylating the polymerization reaction product.

19. A bipolar polymer electrolyte membrane for water electrolysis, which is prepared according to claim 12,
wherein the bipolar polymer electrolyte membrane has a structure in which a proton exchange membrane that is composed of a first compound including a poly(fluorene biphenyl indole) polymer compound as a main chain and an aliphatic hydrocarbon group having a cation exchange group on a side chain of the polymer compound, and an anion exchange membrane that is composed of a second compound represented by the Formula 1 are bonded to each other.
